(19) United States
(12) Patent Application Publication
(10) Pub. No.: US 2013/0188029 A1
(43) Pub. Date: Jul. 25, 2013

(54) ENDOSCOPE SYSTEM AND METHOD FOR CONTROLLING ENDOSCOPE SYSTEM

(71) Applicant: OLYMPUS CORPORATION, Tokyo (JP)

(72) Inventor: Jumpei TAKAHASHI, Tokyo (JP)

(73) Assignee: OLYMPUS CORPORATION, Tokyo (JP)

(21) Appl. No.: 13/735,408

(22) Filed: Jan. 7, 2013

(30) Foreign Application Priority Data
Jan. 24, 2012 (JP) 2012-011975

(51) Int. Cl. H04N 5/232

(52) U.S. Cl. CPC H04N 5/23212
USPC 348/65

(57) ABSTRACT

An endoscope system includes a focus control section that performs a focus control process on an optical system of an endoscopic scope, an operation information acquisition section that acquires operation information about at least one operation among a discharge operation, a suction operation, and a tissue treatment operation based on sensor information from an operation detection sensor, and a switch control section that determines whether or not to cause the focus control section to perform the focus control process based on the operation information.

Japanese Patent Application No. 2012-011975 filed on Jan. 24, 2012, is hereby incorporated by reference in its entirety.

### BACKGROUND

The present invention relates to an endoscope system, a method for controlling an endoscope system, and the like.

An endoscope requires an optical system that can acquire a deep-focus image (i.e., an image in which the near point and the far point are in focus). In recent years, it has become difficult to implement such an optical system due to a decrease in depth of field along with an increase in the number of pixels of an image sensor.

In order to deal with the above problem, JP-A-8-106060 discloses an endoscope apparatus that includes a focal distance driver section that changes the focal distance of the optical system, and performs an autofocus (AF) process on the object. It is possible to always acquire an in-focus image by utilizing the AF process.

JP-A-8-106060 utilizes a contrast AF process as the AF process. The contrast AF process detects the in-focus distance of the optical system based on the contrast value (e.g., high-frequency component or edge quantity) detected from the acquired image. Note that the term “in-focus distance” refers to the position of the system (e.g., that may be the position of the object or lens) in an in-focus state, for example. When the contrast value is calculated while driving the lens, the contrast value becomes a maximum when the position of the focus target object corresponds to the in-focus object distance. Therefore, the contrast AF process detects the contrast value from a plurality of images acquired while changing the focal distance of the optical system, and determines that the focus target object is in focus when the contrast value is a maximum.

### SUMMARY

According to one aspect of the invention, there is provided an endoscope system comprising:

a focus control section that performs a focus control process on an optical system of an endoscopic scope;

an operation information acquisition section that acquires operation information about at least one operation among a discharge operation, a suction operation, and a tissue treatment operation based on sensor information from an operation detection sensor; and

a switch control section that determines whether or not to cause the focus control section to perform the focus control process based on the operation information.

According to another aspect of the invention, there is provided a method for controlling an endoscope system comprising:

acquiring operation information about at least one operation among a discharge operation, a suction operation, and a tissue treatment operation based on sensor information from an operation detection sensor; and

determining whether or not to perform a focus control process on an optical system of an endoscopic scope based on the acquired operation information.

### BRIEF DESCRIPTION OF THE DRAWINGS

FIG. 1 illustrates a configuration example of an endoscope system according to a first embodiment.

FIG. 2 illustrates a configuration example of an image sensor.

FIG. 3 illustrates the spectral characteristics of an image sensor.

FIG. 4 is a view illustrating the relationship between an in-focus object distance and a contrast value.

FIG. 5 illustrates a configuration example of a focus control section.

FIG. 6 illustrates a configuration example of an endoscope system according to a second embodiment.

FIG. 7 illustrates a configuration example of an endoscope system according to a third embodiment.

FIG. 8 illustrates a configuration example of an operation information acquisition section.

FIG. 9 is a view illustrating a method for calculating a reference value used for an attention pixel determination process.

FIGS. 10A to 10D are views illustrating a method that detects a treatment tool from a captured image.

### DESCRIPTION OF EXEMPLARY EMBODIMENTS

According to one embodiment of the invention, there is provided an endoscope system comprising:

a focus control section that performs a focus control process on an optical system of an endoscopic scope;

an operation information acquisition section that acquires operation information about at least one operation among a discharge operation, a suction operation, and a tissue treatment operation based on sensor information from an operation detection sensor; and

a switch control section that determines whether or not to cause the focus control section to perform the focus control process based on the operation information.

According to another embodiment of the invention, there is provided a method for controlling an endoscope system comprising:

acquiring operation information about at least one operation among a discharge operation, a suction operation, and a tissue treatment operation based on sensor information from an operation detection sensor; and

determining whether or not to perform a focus control process on an optical system of an endoscopic scope based on the acquired operation information.

Exemplary embodiments of the invention are described below. Note that the following exemplary embodiments do not in any way limit the scope of the invention laid out in the claims. Note also that all of the elements of the following exemplary embodiments should not necessarily be taken as essential elements of the invention.

Several aspects of the invention relate to a focus control technique when at least one operation among a discharge operation, a suction operation, and a tissue treatment operation is performed. A first embodiment to a third embodiment of the invention are described below. The first embodiment illustrates the focus control process when the discharge operation or the suction operation is performed. The second embodiment and the third embodiment illustrate the focus control process when a treatment tool (e.g., forceps) is inserted during the tissue treatment operation. Note that the second embodiment illustrates a method that directly detects insertion of the treatment tool (i.e., physical operation) using a sensor, a control signal, and the like, and the third embodiment illustrates a method that detects insertion of the treatment tool based on image processing performed on the captured image.

### 1. First Embodiment

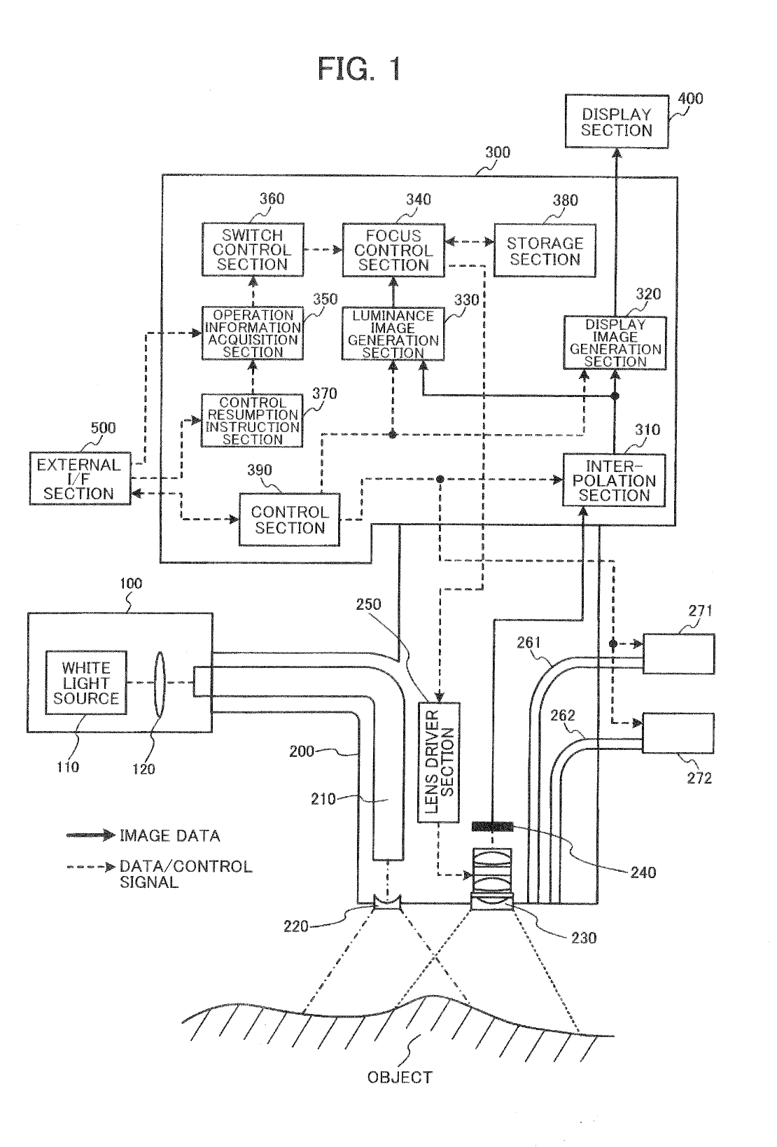

An endoscope system according to the first embodiment is described below with reference to FIG. 1. The endoscope system according to the first embodiment includes a light source section 100, an imaging section 200, an image processing section 300, a display section 400, and an external I/F section 500.

The light source section 100 includes a white light source 110 that emits white light, and a lens 120 that concentrates the white light onto a light guide fiber 210.

The imaging section 200 is formed to be elongate and flexible (i.e., can be curved) so that the imaging section 200 can be inserted into a body cavity. The imaging section 200 includes the light guide fiber 210 that guides the light concentrated by the light source section 100, an illumination lens 220 that diffuses the light guided by the light guide fiber 210, and illuminates an object, a condenser lens 230 that concentrates reflected light from the object, an image sensor 240 that detects the reflected light concentrated by the condenser lens 230, a lens driver section 250, a water supply tube 261, a suction tube 262, a water supply tank 271, and a reservoir tank 272. The lens driver section 250 is connected to the condenser lens 230. The lens driver section 250 is also connected to a focus control section 340 (described later). Note that the imaging section 200 may be hereinafter referred to as “endoscopic scope”.

When an object such as a residue that hinders endoscopic diagnosis is present, the residue is washed away by supplying water. The water supply tank 271 and the water supply tube 261 are used to supply water. Specifically, water is supplied from the water supply tank 271 through the water supply tube 261. The water supply tank 271 stores water to be supplied. When diagnosing the stomach, gastric juice is sucked up when it hinders diagnosis. The reservoir tank 272 and the suction pipe 262 are used to suck gastric juice or the like. Specifically, gastric juice is sucked up through the suction pipe 262, and stored in the reservoir tank 272.

The water supply tank 271 and the reservoir tank 272 are connected to a control section 390 (described later). The user issues a water supply instruction or a suction instruction through the external I/F section 500 by pressing a water supply button or a suction button (not illustrated in FIG. 1) (described later).

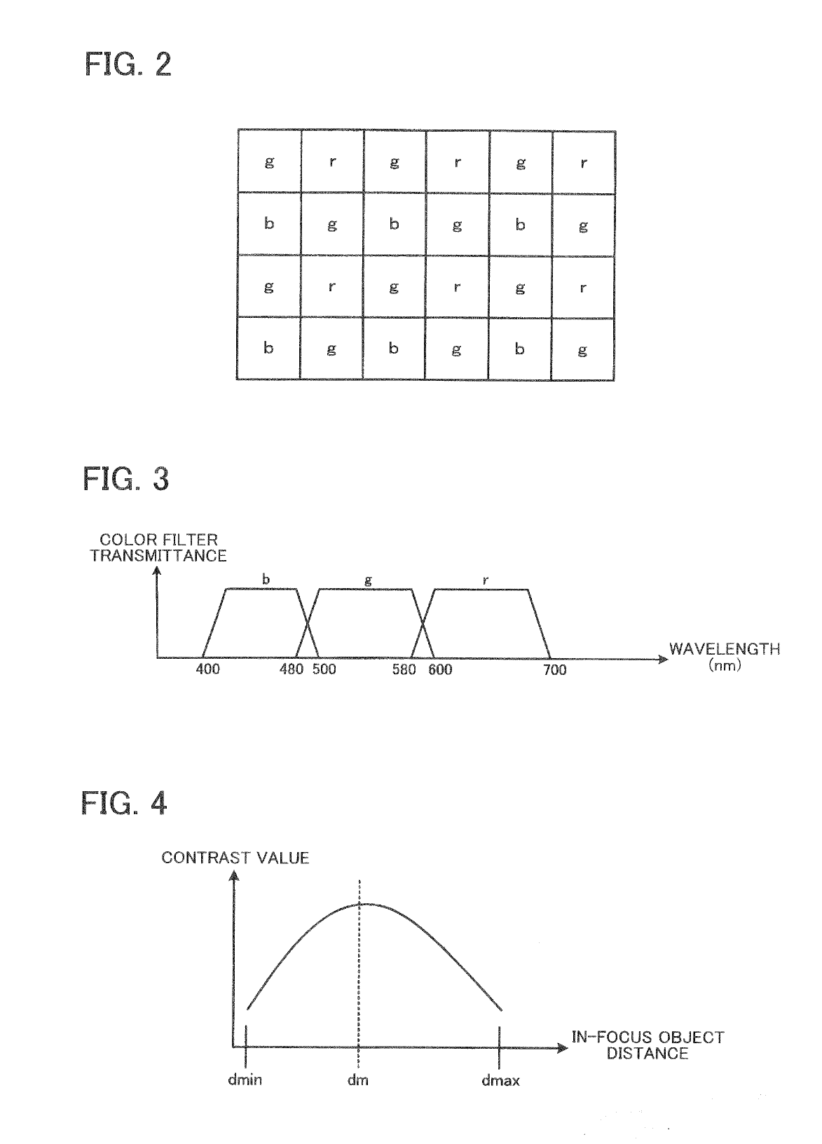

The image sensor 240 includes a Bayer array illustrated in FIG. 2. As illustrated in FIG. 3, the filter r allows light having a wavelength of 580 to 700 nm to pass through, the filter g allows light having a wavelength of 480 to 600 nm to pass through, and the filter b allows light having a wavelength of 400 to 500 nm to pass through.

The condenser lens 230 is configured so that the in-focus object distance can be controlled. More specifically, the in-focus object distance can be adjusted within the range of dmin to dmax (mm) (dmax>dmin) Note that the term “in-focus object distance” used herein refers to the distance between the condenser lens 230 and the object in an in-focus state. In other words, the endoscope system according to the first embodiment can focus on the object that is present at a distance of dmin to dmax (mm) from the condenser lens 230 by adjusting the condenser lens 230.

The external I/F section 500 is an interface that allows the user to perform an input operation or the like on the endoscope system. The external I/F section 500 includes a power switch (power ON/OFF switch), a mode (e.g., imaging mode) switch button, and the like. The external I/F section 500 includes a water supply button for supplying water, and a suction button for sucking gastric juice or the like.

The external I/F section 500 is connected to an operation information acquisition section 350 and the control section 390 (described later). The external I/F section 500 outputs input information to the control section 390. The external I/F section 500 also outputs information about a water supply/suction operation (i.e., information about whether or not the water supply button or the suction button has been pressed) to the operation information acquisition section 350.

The image processing section 300 includes an interpolation section 310, a display image generation section 320, a luminance image generation section 330, a focus control section 340, the operation information acquisition section 350, a switch control section 360, a control resumption instruction section 370, a storage section 380, and the control section 390. Note that the image processing section 300 is not limited to the configuration illustrated in FIG. 1. Various modifications may be made, such as omitting some (e.g., control resumption instruction section 370) of the elements or adding other elements.

The interpolation section 310 is connected to the display image generation section 320 and the luminance image generation section 330. The display image generation section 320 is connected to the display section 400. The luminance image generation section 330 is connected to the focus control section 340. The focus control section 340 is connected to the lens driver section 250 and the storage section 380. The operation information acquisition section 350 is connected to the switch control section 360. The switch control section 360 is connected to the focus control section 340. The control resumption instruction section 370 is connected to the operation information acquisition section 350. The control section 390 is connected to the interpolation section 310, the display image generation section 320, the luminance image generation section 330, the water supply tank 271, and the reservoir tank 272, and controls the interpolation section 310, the display image generation section 320, the luminance image generation section 330, the water supply tank 271, and the reservoir tank 272.

When a water supply instruction or a suction instruction has been issued using the external I/F section 500 (i.e., when the water supply button or the suction button has been pressed), the control section 390 outputs information about the water supply instruction or the suction instruction to the water supply tank 271 or the reservoir tank 272 as a trigger signal. More specifically, the control section 390 outputs the trigger signal to the water supply tank 271 when the water supply instruction has been issued. The trigger signal is continuously output during a period in which the water supply button is being pressed. The water supply tank 271 supplies water during a period in which the trigger signal is being output. The control section 390 outputs the trigger signal to the reservoir tank 272 when the suction instruction has been issued. The reservoir tank 272 sucks gastric juice or the like during a period in which the trigger signal is being output.

The interpolation section 310 performs an interpolation process on an image acquired by the image sensor 240. Since the image sensor 240 has the Bayer array illustrated in FIG. 2, each pixel of the image acquired by the image sensor 240 has only the R, G or B signal value (i.e., the other signal values are missing).

The interpolation section 310 interpolates the missing signal values by performing the interpolation process on each pixel of the image to generate an image in which each pixel has the R, G, and B signal values (hereinafter referred to as “RGB image”). The interpolation process may be implemented by a known bicubic interpolation process, for example. The interpolation section 310 outputs the RGB image to the display image generation section 320 and the luminance image generation section 330.

The display image generation section 320 performs a white balance process, a color conversion process, a grayscale transformation process, and the like on the RGB image output from the interpolation section 310 to generate a display image. The display image generation section 320 outputs the display image to the display section 400.

The luminance image generation section 330 generates a luminance image from the RGB image output from the interpolation section 310. More specifically, the luminance image generation section 330 calculates a luminance signal Y of each pixel of the RGB image using the following expression (1) to generate the luminance image. The luminance image generation section 330 outputs the luminance image to the focus control section 340.

Y=0.213R+0.715G+0.072B (1)

The focus control section 340 performs a focus control process on the optical system. More specifically, the focus control section 340 calculates a contrast value from the luminance image output from the luminance image generation section 330, detects the position of the focus target object by a method described below based on the contrast value (the position thus detected may be hereinafter referred to as “detection in-focus distance”), and performs a control process so that the in-focus object distance is achieved. A high-frequency component of the luminance image may be used as the contrast value. For example, an output from an arbitrary high-pass filter (HPF) may be used as the contrast value.

The detection in-focus distance is detected as described below. When the object in the captured image is the focus target object, the contrast value calculated from the captured image (luminance image) normally becomes a maximum in an in-focus state. For example, when the focus target object (i.e., part or the entirety of the object in the captured image) is positioned at a distance of dm (dmin<dm<dmax) from the condenser lens 230 (note that the distance dm is calculated using a given sensor or image processing, and the user need not take account of the distance dm when using the method according to the first embodiment), the in-focus object distance and the contrast value have the relationship illustrated in FIG. 4 when the in-focus object distance is changed by adjusting the condenser lens 230. Specifically, the contrast value calculated from the captured image becomes a maximum when the condenser lens 230 is adjusted so that the in-focus object distance is dm.

Therefore, the focus control section 340 detects a state in which the contrast value of the luminance image output from the luminance image generation section 330 becomes a maximum as an in-focus state, and controls the lens driver section 250 so that the in-focus state is achieved.

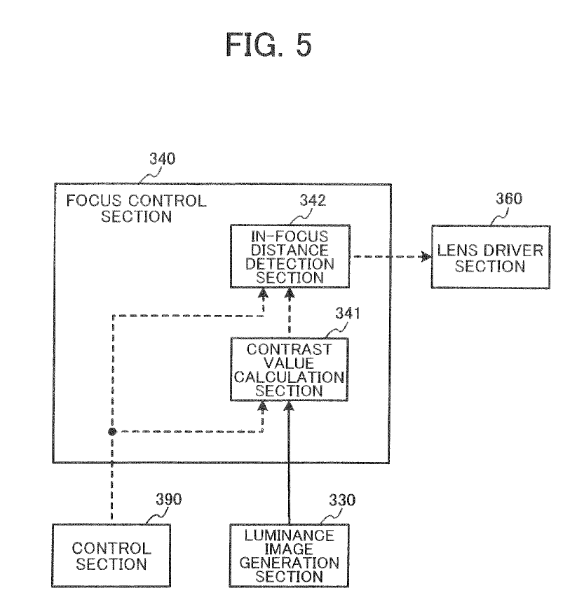

The details of the focus control section 340 are described below with reference to FIG. 5. As illustrated in FIG. 5, the focus control section 340 includes a contrast value calculation section 341 and an in-focus distance detection section 342.

The luminance image generation section 330 is connected to the contrast value calculation section 341. The contrast value calculation section 341 is connected to the in-focus distance detection section 342. The in-focus distance detection section 342 is connected to the lens driver section 250. The control section 390 is connected to the contrast value calculation section 341 and the in-focus distance detection section 342.

The flow of the in-focus state (detection in-focus distance) detection process is described below. Note that the following process (focus process) is hereinafter referred to as “AF process”.

A wobbling width ±dw and a step width (i.e., updated in-focus object distance) dn during hill-climbing AF have been set in advance. When the AF process has started, the in-focus distance detection section 342 changes the in-focus object distance of the condenser lens 230 to ds-dw (where, ds is the initial value of the in-focus object distance) via the lens driver section 250. The contrast value calculation section 341 calculates a contrast value C_{-dw} from the luminance image output from the luminance image generation section 330, and outputs the contrast value C_{-dw} to the in-focus distance detection section 342.

The in-focus distance detection section 342 changes the in-focus object distance of the condenser lens 230 to ds+dw via the lens driver section 250. The contrast value calculation section 341 calculates a contrast value C_{+dw} from the luminance image output from the luminance image generation section 330, and outputs the contrast value C_{+dw} to the in-focus distance detection section 342.

The in-focus distance detection section 342 compares the contrast value C_{-dw} with the contrast value C_{+dw}, and updates the initial value ds of the in-focus object distance. More specifically, the in-focus distance detection section 342 decreases the initial value ds by dn when C_{-dw}>C_{+dw}, and increases the initial value ds by dn when C_{+dw}>C_{-dw}.

The in-focus distance detection section 342 then changes the in-focus object distance by ±dw with respect to the updated initial value ds, and calculates the contrast value and the like.

The endoscope system according to the first embodiment detects the in-focus state (or the detection in-focus distance) using the above method. Note that the values dw and dn may set to a constant value in advance, or may be set to an arbitrary value by the user via the external I/F section 500.

The operation information acquisition section 350 outputs a trigger signal to the switch control section 360 when the water supply instruction or the suction instruction has been issued using the external I/F section 500 (i.e., when the water supply button or the suction button has been pressed). The switch control section 360 outputs a suspension signal that instructs the focus control section 340 to suspend the AF process to the focus control section 340 when the operation information acquisition section 350 has output the trigger signal. Note that the trigger signal and the suspension signal are continuously output during a period in which the water supply button or the suction button is being pressed.

The focus control section 340 suspends the AF process during a period is which the suspension signal is being output from the switch control section 360. The focus control section 340 resumes the AF process when the switch control section 360 has stopped outputting the suspension signal (i.e., when water supply or suction has completed).

The control resumption instruction section 370 transmits a signal to the operation information acquisition section 350 when a focus control compulsory resumption instruction has been issued using the external I/F section 500. The operation information acquisition section 350 does not output the trigger signal to the switch control section when a signal that indicates the compulsory resumption instruction has been input even if the trigger signal that indicates the water supply instruction or the suction instruction has been input. Specifically, the focus control process is performed even when the water supply operation or the suction operation is performed. The details thereof are described later in connection with a modification of the first embodiment.

An image acquired during the water supply operation is characterized by a number of bright spots. The bright spot has a contrast value larger than that of tissue, and changes in shape to a large extent with the lapse of time. Therefore, the contrast value calculated by the contrast value calculation section 341 changes to a large extent during the water supply operation due to a change in shape of the bright spot (i.e., the relationship illustrated in FIG. 4 is not satisfied). Since the end of the endoscopic scope is immersed in gastric juice during the suction operation, an image acquired during the suction operation has low contrast (i.e., gastric juice is present over the entire image). Since the contrast AF process controls the in-focus object distance of the condenser lens 230 based on the contrast value, the contrast AF process does not effectively function during the suction operation.

Specifically, it is difficult to detect the in-focus object distance (i.e., the in-focus object distance changes frequently) during the water supply operation or the suction operation. Therefore, an image acquired during the water supply operation or the suction operation is not suitable for diagnosis (i.e., hinders diagnosis performed by the doctor), and increases the burden on the doctor.

On the other hand, since the endoscopic scope is rarely moved to a large extent during the water supply operation or the suction operation, a change in in-focus object distance during the water supply operation or the suction operation is small.

Therefore, the AF process is suspended during the water supply operation or the suction operation using the above method. As a result, since the in-focus object distance is fixed during the water supply operation or the suction operation, it is possible to solve the problem in which the in-focus object distance changes frequently.

Although an example in which an output from the HPF is used as the contrast value has been described above, the invention is not limited thereto. For example, slope information or an edge quantity of the luminance image may be used as the contrast value. The term “slope information” used herein refers to information about the slope of the luminance signal of the luminance image in an arbitrary direction. For example, the difference between the luminance signal of an attention pixel (slope information calculation target) and the luminance signal of at least one peripheral pixel that is positioned away from the attention pixel in the horizontal direction by at least one pixel may be calculated and used as the slope (slope information) of the luminance signal in the horizontal direction. A weighted average value of the slope information calculated in a plurality of directions may be used as the edge quantity.

Although an example in which the AF process is necessarily suspended during the water supply operation or the suction operation has been described above, the invention is not limited thereto. For example, an AF resumption button for compulsorily resuming the AF process may be provided to the external I/F section 500. In this case, information about the AF resumption button (i.e., whether or not the AF resumption button has been pressed) is output to the control resumption instruction section 370. The control resumption instruction section 370 outputs a signal to the operation information acquisition section 350 when the AF resumption button has been pressed. The operation information acquisition section 350 does not output the trigger signal to the switch control section 360 when a control resumption signal has been output from the control resumption instruction section 370 even when a signal that indicates that the water supply button or the suction is being pressed is output from the external I/F section 500.

Note that the configuration of the image processing section 300 is not limited to the above configuration. For example, the control resumption instruction section 370 may output a signal to the switch control section 360. In this case, the switch control section 360 switches the focus control operation based on the ON/OFF combination of the signal output from the operation information acquisition section 350 and the signal output from the control resumption instruction section 370. More specifically, the AF process is basically suspended when the signal output from the operation information acquisition section 350 is being input, but is resumed (performed) regardless of the presence or absence of the signal output from the operation information acquisition section 350 when the signal output from the control resumption instruction section 370 has been input. The above configuration makes it possible to compulsorily resume the AF process during the water supply operation or the suction operation.

For example, the suction operation may be performed in order to lift the lesion area instead of removing gastric juice or the like. Specifically, the lesion area may be sucked toward the end of the endoscopic scope (i.e., the lesion area is lifted) by attaching a hood to the end of the endoscopic scope, and performing the suction operation in a state in which the end of the hood adheres to the lesion area. The lesion area can be easily excised by lifting the lesion area. In this case, it is desirable to perform the AF process since an image having sufficient contrast is acquired. An in-focus image can be acquired by resuming the AF process by pressing the AF resumption button.

Although an example in which the water supply button, the suction button, and the AF resumption button are provided to the external I/F section 500 has been described above, the invention is not limited thereto. For example, the water supply button, the suction button, and the AF resumption button may be provided to the imaging section 200 or the light source section 100.

The above method makes it possible to solve the problem in which the in-focus object distance changes frequently during the water supply operation or the suction operation. This makes it possible to display an image suitable for diagnosis during the water supply operation or the suction operation.

Moreover, since it is unnecessary to provide a suspension button for suspending the AF process, it is possible to solve the above problem without requiring a complex operation (i.e., without increasing the burden on the doctor).

According to the first embodiment, the endoscope system includes the focus control section 340 that performs the focus control process on the optical system of the endoscopic scope, the operation information acquisition section 350 that acquires operation information based on sensor information from an operation detection sensor, and the switch control section 360 that determines whether or not to cause the focus control section 340 to perform the focus control process based on the operation information (see FIG. 1). The operation information is information about whether or not at least one operation among a discharge operation, a suction operation, and a tissue treatment operation is performed on the operation section. The discharge operation may be an operation that discharges at least one of a liquid and a solid. More specifically, the discharge operation may be a water supply operation that discharges water as the liquid.

The operation detection sensor is a sensor for detecting an operation. For example, the operation detection sensor may be a dedicated operation detection sensor or the like that is provided to the operation section (e.g., external I/F section 500), and detects a physical operation or the like performed on the operation section. More specifically, the operation detection sensor may be a sensor or the like that is provided to a physical button of the operation section, detects that the physical button has been pressed, and outputs a control signal that corresponds to the button press operation to each section of the endoscope system as the sensor information. When a dial is provided to the operation section, the operation detection sensor may be a sensor that detects the rotation of the dial. When a touch panel is provided to the operation section, the operation detection sensor may be a pressure-sensitive or capacitive touch detection sensor.

The operation detection sensor need not necessarily be provided to the operation section, but may be provided at a given position in the endoscope system. For example, the operation detection sensor may be a water level sensor provided to the water supply tank 271 or the reservoir tank 272. It may be detected that the water supply operation is performed when the water level of the water supply tank 271 has decreased, and it may be detected that the suction operation is performed when the water level of the reservoir tank 272 has increased. A detection sensor 291 (described later) that detects the movement of forceps in a channel or the like may also be used. Note that the operation detection sensor is a sensor for detecting an operation (dedicated operation detection sensor in a narrow sense), and the image sensor 240 and the like do not fall under the term “operation detection sensor”. Since the image sensor 240 is not provided for detecting an operation, and an operation (e.g., water supply to the imaging target tissue, or approach of forceps to the imaging target tissue) cannot be detected when the image processing section 300 has not performed appropriate image processing, the image sensor 240 differs from the operation detection sensor according to the first embodiment.

The focus control process is a control process that adjusts the state of the optical system. For example, the focus control process may be an AF control process that controls the lens driver section 250 so that a given object in the captured image is in focus. Although the contrast AF process has been mentioned above as a specific example of the AF process, a phase detection AF process or the like may be used as the AF process. For example, since the phase detection AF process acquires information about the object image as phase information, a clear object image cannot be acquired (i.e., the AF process is not effective) during the water supply operation or the suction operation in the same manner as the contrast AF process.

The above configuration makes it possible for the endoscope system that includes the focus control section 340 that performs the focus control process (AF process in a narrow sense) to determine whether or not to perform the focus control process based on whether or not at least one operation among the discharge operation, the suction operation, and the tissue treatment operation is performed. The AF process may not effectively function due to an object (e.g., liquid or solid (water in a narrow sense)) discharged by the discharge operation, or an object (e.g., gastric juice) sucked by the suction operation. The AF process may also not effectively function due to a treatment tool or the like used for the treatment operation. Specifically, the method according to the first embodiment makes it possible to perform the AF process when the AF process is effective, and suspend the AF process when the AF process is not effective. In particular, since the endoscope system may be brought into focus on an undesired object, or the image may be difficult to observe due to a frequent change in the in-focus object distance when the AF process is performed even if the AF process is not effective, diagnosis performed by the user or the like may be hindered. Therefore, it is important to avoid such a situation.

The switch control section 360 may cause the focus control section 340 to suspend the focus control process when it has been determined that the at least one operation (i.e., at least one operation among the discharge operation, the suction operation, and the tissue treatment operation) is performed. The switch control section 360 may cause the focus control section 340 to resume the focus control process when it has been determined that the at least one operation has completed.

Note that the at least one operation used as the determination target when resuming the focus control process refers to the operation that has resulted in suspension of the focus control process. For example, when the focus control process has been suspended when it has been determined that the discharge operation is performed, the focus control process is resumed when it has been determined that the discharge operation has completed. This also applies to the suction operation and the tissue treatment operation. When two or more operations have been performed at the same time (the two or more operations need not necessarily be started at the same time (e.g., when the discharge operation has been performed, and the suction operation has been performed before completion of the discharge operation)), the at least one operation used as the determination target when resuming the focus control process refers to the two or more operations (e.g., discharge operation and suction operation).

According to the above configuration, since the AF process is suspended when an operation that hinders the AF process is performed, it is possible to suppress an undesirable behavior. Moreover, since the AF process is resumed when the operation that hinders the AF process has completed, it is possible to focus on the object without forcing the user to operate the endoscope system.

As illustrated in FIG. 1, the endoscope system may include the storage section 380 that stores a control parameter that indicates the state of the optical system. The storage section 380 may store the control parameter when the switch control section 360 has caused the focus control section 340 to suspend the focus control process.

Note that the control parameter indicates the state of the optical system, and may be a parameter that indicates the position of the lens system including the condenser lens 230, for example. When the lens position is linked to the in-focus object distance, the control parameter may be a parameter that indicates the in-focus object distance.

The above configuration makes it possible to store the state of the optical system when the focus control process has been suspended. Since the focus control process effectively functions immediately before the focus control process is suspended, it is considered that the desired object is in focus. Since the discharge operation (particularly the water supply operation) and the suction operation are performed to remove a residue, gastric juice, or the like that hinders observation of the object, the user checks whether or not the removal operation has successfully completed. Specifically, it is considered that the relative positions of the object and the imaging section 200 do not change to a large extent during a period in which the discharge operation or the suction operation is being performed. Therefore, since the state of the optical system when the focus control process has been suspended is useful for maintaining the in-focus state or the like after the focus control process has been suspended, it is desirable to store the state of the optical system as a parameter. Since it is considered that the tissue treatment operation is performed on the object that has been observed immediately before the tissue treatment operation is performed (e.g., immediately before a treatment tool is inserted), a change in relative positions of the object and the imaging section 200 is considered to be small.

When the endoscope system includes the storage section 380 that stores the control parameter, the focus control section 340 may acquire the control parameter when the focus control section 340 has suspended the focus control process from the storage section 380 when the switch control section 360 has caused the focus control section 340 to resume the focus control process. The focus control section 340 may set an initial value of the resumed focus control process based on the acquired control parameter.

This makes it possible to resume the focus control process based on the state when the focus control process has been suspended. It is considered that the relative positions of the object and the imaging section 200 do not change to a large extent during the discharge operation, the suction operation, and the tissue treatment operation. Therefore, it is likely that the desired object is in focus, or a similar state is implemented when the operation has completed, and the focus control process has been resumed, and it is expected that the control process for achieving the in-focus state is facilitated by performing the control process based on the state when the focus control process has been suspended. Specifically, the in-focus object distance when the focus control process has been suspended may be acquired as the control parameter (or may be acquired based on the control parameter), and the acquired value may be used as the initial value ds of the in-focus object distance that has been described above in connection with the contrast AF process.

The focus control section 340 may perform a focus fix control process when the switch control section 360 has caused the focus control section 340 to suspend the focus control process until the switch control section 360 causes the focus control section 340 to resume the focus control process.

The focus fix control process may fix the lens position, or may fix the in-focus object distance.

This makes it possible to maintain the state of the optical system when the focus control process has been suspended until the focus control process is resumed. This is because it is considered that the relative positions of the object and the imaging section 200 do not change to a large extent during the discharge operation, the suction operation, and the tissue treatment operation. Since the storage section 380 need not necessarily be provided, and the control parameter or the like need not necessarily be stored when the focus is fixed until the suspended focus control process is resumed, the control process is facilitated.

As illustrated in FIG. 1, the endoscope system may include the control resumption instruction section 370 that instructs the focus control section 340 to resume the focus control process. The switch control section 360 may cause the focus control section 340 to resume the focus control process when the control resumption instruction section 370 has instructed the focus control section 340 to resume the focus control process even when the switch control section 360 has caused the focus control section 340 to suspend the focus control process based on the operation information.

This makes it possible to compulsorily resume the focus control process even when the focus control process has been suspended based on the operation information. The control resumption instruction section 370 may instruct the focus control section 340 to resume the focus control process based on an operation performed by the user on the operation section (external I/F section 500). More specifically, the focus control process is resumed when the suction operation has been performed in order to lift tissue instead of sucking gastric juice, for example. Specifically, since the end of the imaging section 200 is not immersed in liquid when lifting tissue, the focus control process (AF) effectively functions.

The switch control section 360 may cause the focus control section 340 to suspend the focus control process when it has been determined that the discharge operation or the suction operation is performed based on the operation information.

This makes it possible to suspend the focus control process when the discharge operation or the suction operation has been performed. This is because it is considered that the AF process does not effectively function when the discharge operation or the suction operation is performed. Note that the reasons why the AF process does not effectively function are the same as described above.

The switch control section 360 may cause the focus control section 340 to resume the focus control process when it has been determined that the discharge operation or the suction operation has completed based on the operation information.

This makes it possible to resume the focus control process when the discharge operation or the suction operation has completed. Therefore, since the AF process is positively performed unless the AF process does not effectively function, the burden on the user due to the focus operation can be reduced.

### 2. Second Embodiment

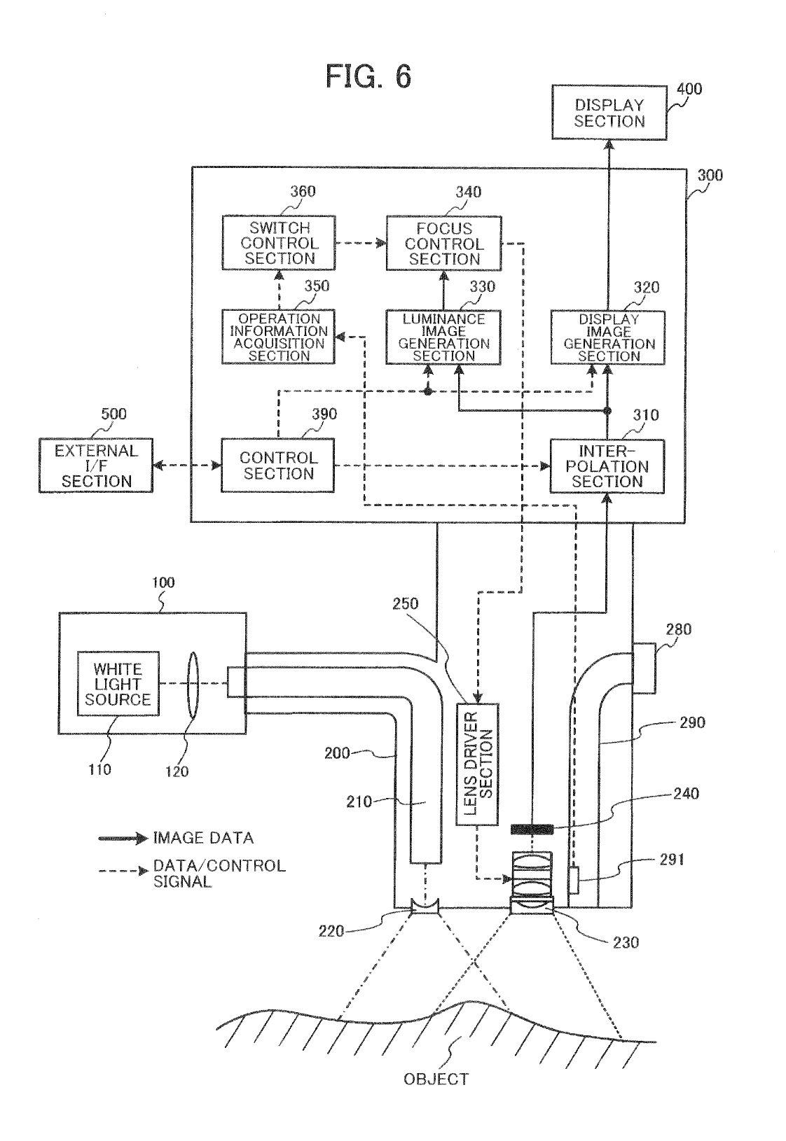

An endoscope system according to the second embodiment is described below with reference to FIG. 6. The endoscope system according to the second embodiment includes a light source section 100, an imaging section 200, an image processing section 300, a display section 400, and an external I/F section 500.

The configurations of the light source section 100 and the display section 400 are the same as those described above in connection with the first embodiment. The external I/F section 500 differs from the external I/F section 500 according to the first embodiment in that the water supply button and the suction button are omitted. The image processing section 300 differs from the image processing section 300 according to the first embodiment in that the control resumption instruction section 370 and the storage section 380 are omitted, and the operation information acquisition section 350 is configured in a different way. Note that the image processing section 300 according to the second embodiment may include at least one of the control resumption instruction section 370 and the storage section 380.

Note that the following description focuses on the elements that have a configuration differing from that described above in connection with the first embodiment, and description of the elements that have the same configuration as that described above in connection with the first embodiment is omitted.

The imaging section 200 differs from the imaging section 200 according to the first embodiment in that the water supply tube 261, the water supply tank 271, the suction pipe 262, and the reservoir tank 272 are omitted, and an insertion opening 280, a forceps channel 290, and a detection sensor 291 are additionally provided. The detection sensor 291 is connected to the operation information acquisition section 350.

A treatment tool (e.g., forceps) is inserted into the insertion opening 280. The insertion opening 280 communicates with the forceps channel 290 into which the treatment tool is inserted. The detection sensor 291 is provided at the end of the forceps channel 290 that is positioned on the side of the condenser lens 230, and detects whether or not the treatment tool is inserted. For example, the sensor may be a button that is pressed by the treatment tool when the treatment tool has been inserted to reach the end of the forceps channel.

The detection sensor 291 outputs the detection result (as to whether or not the treatment tool is inserted) to the operation information acquisition section 350. The operation information acquisition section 350 outputs a trigger signal that indicates detection of the treatment tool to the switch control section 360 when the detection sensor 291 has detected the treatment tool. The switch control section 360 outputs a suspension signal that instructs the focus control section 340 to suspend the AF process to the focus control section 340 when the operation information acquisition section 350 has output the trigger signal. Note that the trigger signal and the suspension signal are continuously output during a period in which the treatment tool is being detected.

The treatment tool is present in the image acquired by the image sensor 240 when the treatment tool is inserted. The treatment tool has a large contrast value as compared with tissue. Therefore, a problem in which the treatment tool is in focus (i.e., the diagnosis target tissue is out of focus) occurs when the treatment tool is inserted.

On the other hand, since a lesion is treated when the treatment tool is inserted, the endoscopic scope is rarely moved to a large extent. Therefore, a change in the in-focus object distance is small.

In the second embodiment, the AF process is suspended when the treatment tool has been detected by the detection sensor 291 (i.e., when the treatment tool is inserted). The AF process is resumed when the detection sensor 291 does not detect the treatment tool (i.e., when the treatment tool has been removed). Therefore, since the in-focus object distance is fixed when the treatment tool is inserted, it is possible to solve the above problem.

Although an example in which the detection sensor 291 is provided at the end of the forceps channel 290 that is positioned on the side of the condenser lens 230 has been described above, the detection sensor 291 may be provided at the end of the forceps channel 290 that is positioned on the side of the insertion opening 280, or may be provided in the insertion opening 280.

The above method makes it possible to solve the problem in which tissue is out of focus when the treatment tool is inserted. This makes it possible to display an image suitable for diagnosis even when the treatment tool is inserted without requiring a complex operation.

According to the second embodiment, the operation information acquisition section 350 may acquire information that indicates whether or not the treatment tool for performing the tissue treatment operation is inserted as the operation information. The switch control section 360 may cause the focus control section 340 to suspend the focus control process when it has been determined that the treatment tool is inserted based on the operation information.

This makes it possible to suspend the focus control process when the tissue treatment operation has been performed taking account of the insertion operation of the treatment tool. This is because it is considered that the AF process does not effectively function when the tissue treatment operation is performed. Note that the reasons why the AF process does not effectively function are the same as described above.

The switch control section 360 may cause the focus control section 340 to resume the focus control process when it has been determined that the treatment tool has been removed based on the operation information.

This makes it possible to resume the focus control process when the tissue treatment operation has completed. Therefore, since the AF process is positively performed unless the AF process does not effectively function, the burden on the user due to the focus operation can be reduced.

As illustrated in FIG. 6, the endoscope system may include the forceps channel 290 into which the treatment tool for performing the tissue treatment operation is inserted, and the detection sensor 291 that detects whether or not the treatment tool is inserted. The operation information acquisition section 350 may acquire sensor information from the detection sensor as the operation information about the tissue treatment operation, and the switch control section 360 may determine whether or not to cause the focus control section 340 to perform the focus control process based on the sensor information.

This makes it possible to utilize the sensor information from the detection sensor 291 when detecting insertion of the treatment tool as the operation information. The detection sensor 291 may be a mechanical switch. In this case, the detection sensor 291 outputs a signal to the operation information acquisition section 350 based on whether or not the detection sensor 291 has been pressed by the treatment tool inserted into the forceps channel. The detection sensor 291 may be a non-contact sensor that emits infrared light, and detects reflected light, for example.

### 3. Third Embodiment

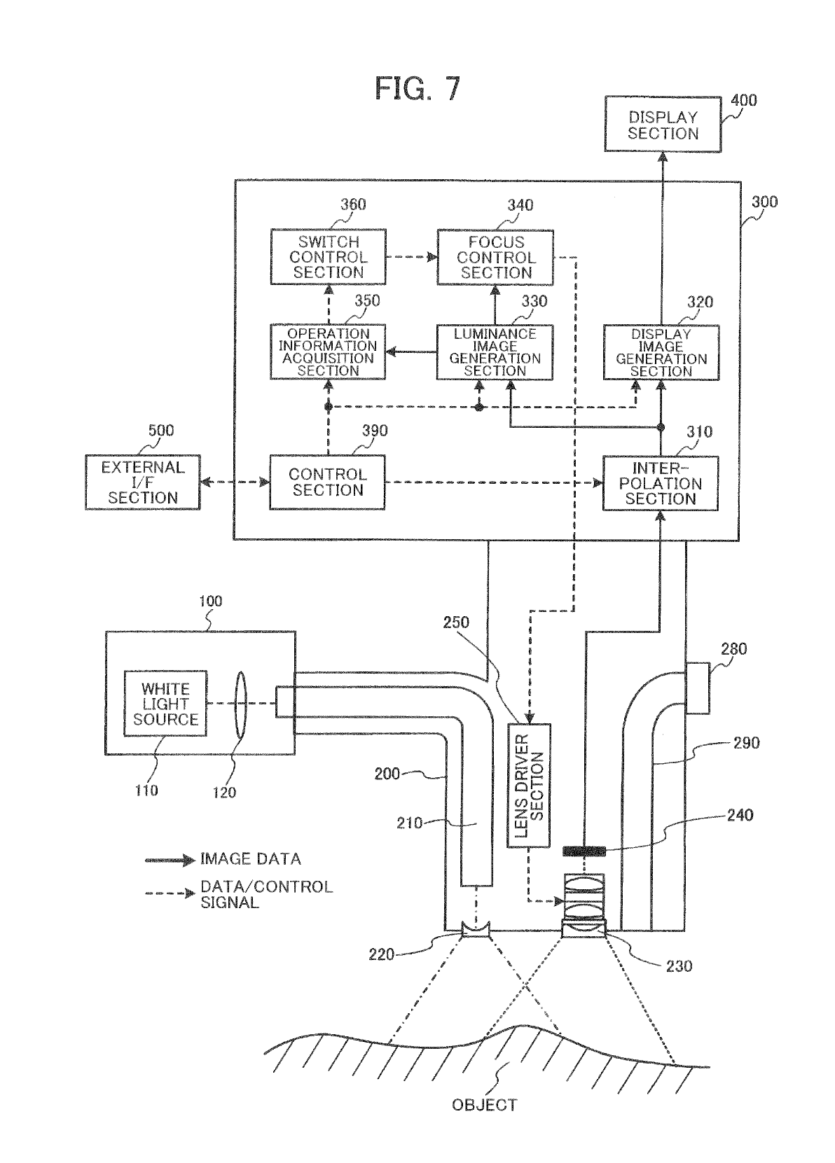

An endoscope system according to the third embodiment is described below with reference to FIG. 7. The endoscope system according to the third embodiment includes a light source section 100, an imaging section 200, an image processing section 300, a display section 400, and an external I/F section 500. Note that the elements other than the imaging section 200 and the image processing section 300 are the same as those described above in connection with the second embodiment, and description thereof is omitted. In the first and second embodiments, the processing target is limited to the operation information based on the operation detection sensor. In the third embodiment, the operation information based on image processing performed on the captured image is also processed.

The imaging section 200 according to the third embodiment differs from the imaging section 200 according to the second embodiment in that the detection sensor 291 is omitted.

The luminance image generation section 330 is connected to the operation information acquisition section 350, and outputs the generated luminance image. The control section 390 is connected to the operation information acquisition section 350.

The operation information acquisition section 350 detects a treatment tool from the luminance image. The treatment tool is detected by the following method. The operation information acquisition section 350 outputs a trigger signal to the switch control section 360 when the treatment tool has been detected. Note that the trigger signal is continuously output during a period in which the treatment tool is being detected.

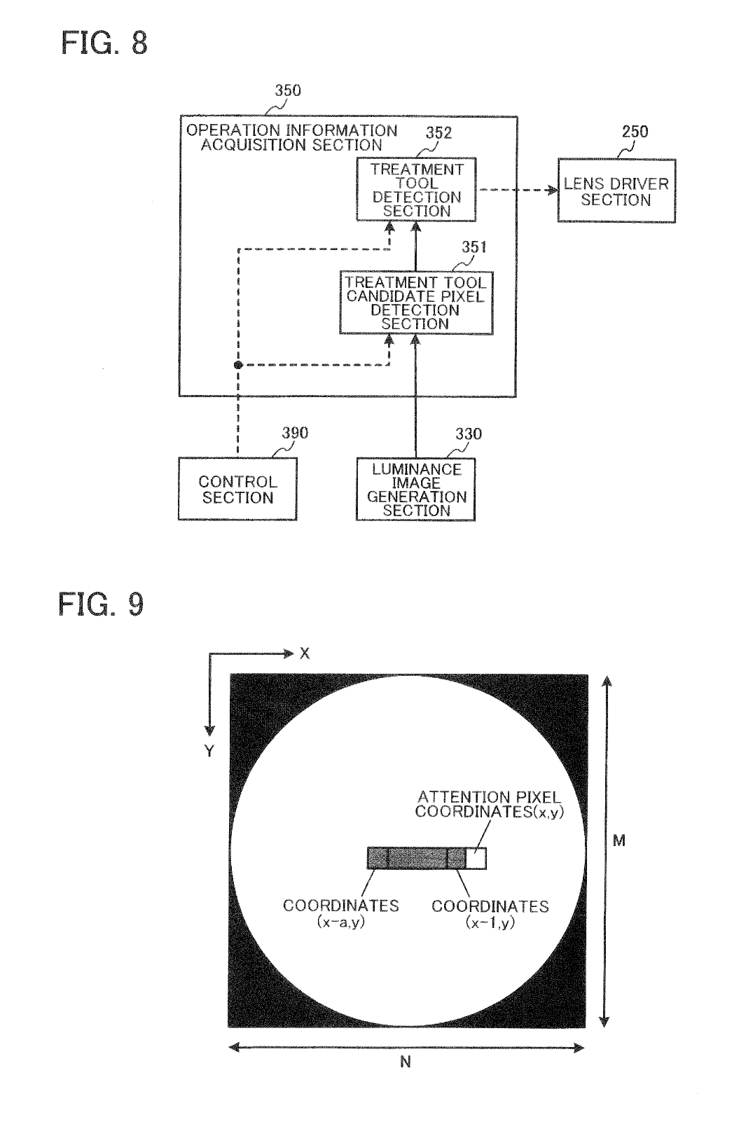

The treatment tool detection method is described below. As illustrated in FIG. 8, the operation information acquisition section 350 includes a treatment tool candidate pixel detection section 351 and a treatment tool detection section 352. The luminance image generation section 330 is connected to the treatment tool candidate pixel detection section 351. The treatment tool candidate pixel detection section 351 is connected to the treatment tool detection section 352. The control section 390 is connected to the treatment tool candidate pixel detection section 351 and the treatment tool detection section 352.

The treatment tool candidate pixel detection section 351 detects pixels (treatment tool candidate pixels) that are considered to correspond to a treatment tool area from the luminance image. The treatment tool candidate pixel detection section 351 outputs the luminance image and the coordinates of the detected treatment tool candidate pixels to the treatment tool detection section 352.

Since the treatment tool is disposed at a position close to the end of the imaging section 200, the luminance signal value of an area of the luminance image that corresponds to the treatment tool is sufficiently larger than that of an area that corresponds to tissue. Therefore, high-luminance pixels of the luminance image are detected as the treatment tool candidate pixels.

The treatment tool candidate pixels are detected by the following method. An example in which the detection process is performed on an attention pixel (x, y) in a luminance image illustrated in FIG. 9 is described below. The luminance signal value of the attention pixel (x, y) is indicated by Y(x, y). The average value Yave(x, y) of the luminance signal values is calculated. Specifically, the average value of the luminance signal values at the coordinates (x-a, y) to (x−1, y) on the left side of the attention pixel (x, y) (see FIG. 9) is calculated as the average value Yave(x, y). The average value Yave(x, y) is calculated by the following expression (2).

$$Yave ( x , y ) = \frac{{\sum }_{i = x - a}^{x - 1} Y ( i , y )}{a} \qquad ( 2 )$$

a in the expression (2) is a constant that is set corresponding to the width N of the luminance image. For example, a is set to be 3% of the width N. Next, whether or not the luminance signal value of the attention pixel (x, y) is sufficiently larger than the average value Yave(x, y) calculated by the expression (2) is determined using the following expression (3). The attention pixel (x, y) that satisfies the relationship shown by the expression (3) is detected as the treatment tool candidate pixel.

Y(x,y)>Yave(x,y)+Yp (3)

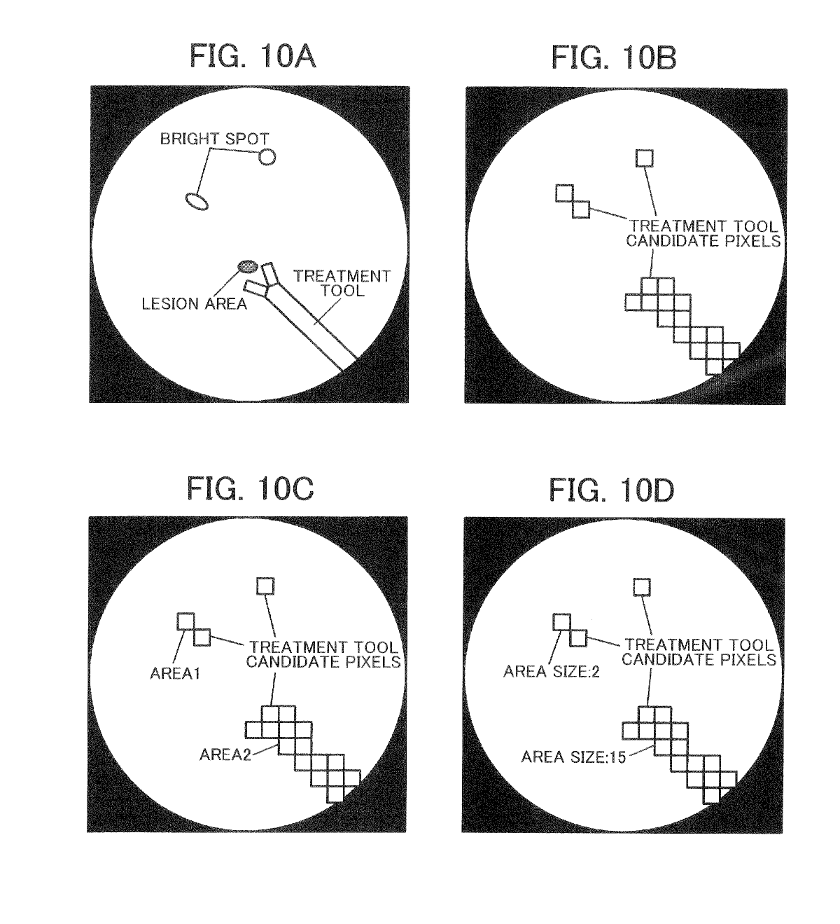

Yp in the expression (3) is a value that is set in advance as a parameter. The user may set an arbitrary value as Yp using the external I/F section 500. For example, the treatment tool candidate pixels illustrated in FIG. 10B are detected from the luminance image illustrated in FIG. 10A that includes an image of the treatment tool and bright spots.

The treatment tool detection section 352 extracts an area that includes a plurality of adjacent pixels detected as the treatment tool candidate pixels as a treatment tool candidate area. An area 1 and an area 2 (see FIG. 10C) are extracted in the example illustrated in FIG. 10B.

The number of pixels (area size) included in each area extracted as the treatment tool candidate area is counted, and an area that includes the largest number of pixels is extracted. In this case, since the area size of the area 1 is 2, and the area size of the area 2 is 15 (see FIG. 10D), the area 2 is extracted.

When the area size of the extracted area (area 2) is larger than a threshold value Sth set in advance, the extracted area is detected as the treatment tool (i.e., it is determined that the treatment tool is inserted). When the area size of the extracted area (area 2) is equal to or smaller than the threshold value Sth, it is determined that the treatment tool is not inserted. For example, the area 2 is detected as the treatment tool when the threshold value Sth is “10”.

Although an example in which the treatment tool is detected from the luminance image has been described above, the invention is not limited thereto. For example, the treatment tool may be detected from the RGB image output from the interpolation section 310. In this case, the treatment tool may be detected in the same manner as described above using the G signal. Although an example in which the treatment tool is detected based on the luminance information has been described above, the invention is not limited thereto. For example, the treatment tool may be detected using hue information or chroma information.

The above method makes it possible to solve the problem in which tissue is out of focus when the treatment tool is inserted. This makes it possible to display an image suitable for diagnosis even when the treatment tool is inserted without requiring a complex operation. Moreover, since it is unnecessary to provide a sensor that detects the treatment tool, the configuration can be simplified.

According to the third embodiment, the endoscope system may include the focus control section 340 that performs the focus control process on the optical system of the endoscopic scope, the operation information acquisition section 350 that acquires the operation information that indicates whether or not the tissue treatment operation is performed, and the switch control section 360 that determines whether or not to cause the focus control section 340 to perform the focus control process based on the operation information (see FIG. 7). The operation information acquisition section 350 may acquire the operation information based on the captured image (e.g., the luminance image generated by the luminance image generation section 330 or the display image generated by the display image generation section 320) generated by the image generation section. The operation information that indicates whether or not the tissue treatment operation is performed may be information that indicates whether or not the treatment tool used for the treatment operation is inserted.

This makes it possible to detect whether or not the tissue treatment operation is performed (i.e., whether or not the treatment tool is inserted) based on the captured image, and determine whether or not to perform the focus control process (AF process) based on the detection result. More specifically, the AF process is suspended when the tissue treatment operation is performed, and is resumed when the tissue treatment operation has completed. The reason why the above control process is performed has been described above in connection with the second embodiment.

The operation information acquisition section 350 may acquire the operation information based on the pixel value of each pixel of the captured image. Specifically, the operation information acquisition section 350 may acquire the luminance image as the captured image, and may acquire the operation information based on the luminance value of the luminance image. More specifically, the operation information acquisition section 350 may detect adjacent treatment tool candidate pixels (i.e., pixels of the luminance image having a luminance value larger than a given reference value) as the treatment tool candidate area, and may acquire the operation information that indicates that the tissue treatment operation is performed when the maximum area of the treatment tool candidate area is larger than a given threshold value.

This makes it possible to acquire the operation information (i.e., detect insertion of the treatment tool) based on the pixel value of the captured image (e.g., luminance image or color display image). Since the operation information can be acquired by image processing, it is unnecessary to provide the detection sensor 291 (see FIG. 6) or the like, and the configuration of the imaging section 200 can be simplified. Since the above process is a simple process based on the pixel value, an increase in processing load can be suppressed.

The first to third embodiments of the invention and the modifications thereof have been described above. Note that the invention is not limited to the first and to third embodiments and the modifications thereof. Various modifications and variations may be made without departing from the scope of the invention. A plurality of elements described in connection with the first to third embodiments and the modifications thereof may be appropriately combined to achieve various configurations. For example, an arbitrary element may be omitted from the elements described in connection with the first to third embodiments and the modifications thereof. Some of the elements described in connection with different embodiments or modifications thereof may be appropriately combined. Any term cited with a different term having a broader meaning or the same meaning at least once in the specification and the drawings may be replaced by the different term in any place in the specification and the drawings. Various modifications and applications are thus possible without materially departing from the novel teachings and advantages of the invention.

What is claimed is:

1. An endoscope system comprising:
a focus control section that performs a focus control process on an optical system of an endoscopic scope;
an operation information acquisition section that acquires operation information about at least one operation among a discharge operation, a suction operation, and a tissue treatment operation based on sensor information from an operation detection sensor; and
a switch control section that determines whether or not to cause the focus control section to perform the focus control process based on the operation information.

2. The endoscope system as defined in claim 1,
the switch control section causing the focus control section to suspend the focus control process when it has been determined that the at least one operation is performed based on the operation information.

3. The endoscope system as defined in claim 2, further comprising:
a storage section that stores a control parameter that indicates a state of the optical system,
the storage section storing the control parameter when the switch control section has caused the focus control section to suspend the focus control process.

4. The endoscope system as defined in claim 1,
the switch control section causing the focus control section to suspend the focus control process when it has been determined that the at least one operation is performed based on the operation information, and causing the focus control section to resume the focus control process when it has been determined that the at least one operation has completed based on the operation information.

5. The endoscope system as defined in claim 4, further comprising:
a storage section that stores a control parameter that indicates a state of the optical system,
the storage section storing the control parameter when the switch control section has caused the focus control section to suspend the focus control process, and
the focus control section acquiring the control parameter when the focus control section has suspended the focus control process from the storage section when the switch control section has caused the focus control section to resume the focus control process, and setting an initial value of the resumed focus control process based on the acquired control parameter.

6. The endoscope system as defined in claim 4,
the focus control section performing a focus fix control process when the switch control section has caused the focus control section to suspend the focus control process until the switch control section causes the focus control section to resume the focus control process.

7. The endoscope system as defined in claim 1, further comprising:
a control resumption instruction section that instructs the focus control section to resume the focus control process,
the switch control section causing the focus control section to resume the focus control process when the control resumption instruction section has instructed the focus control section to resume the focus control process even when the switch control section has caused the focus control section to suspend the focus control process based on the operation information.

8. The endoscope system as defined in claim 1,
the switch control section causing the focus control section to suspend the focus control process when it has been determined that at least one of the discharge operation and the suction operation is performed based on the operation information.

9. The endoscope system as defined in claim 8,
the switch control section causing the focus control section to resume the focus control process when it has been determined that the at least one of the discharge operation and the suction operation has completed based on the operation information.

10. The endoscope system as defined in claim 1,
the operation information acquisition section acquiring information that indicates whether or not a treatment tool for performing the tissue treatment operation is inserted as the operation information, and
the switch control section causing the focus control section to suspend the focus control process when it has been determined that the treatment tool is inserted based on the operation information.

11. The endoscope system as defined in claim 10,
the switch control section causing the focus control section to resume the focus control process when it has been determined that the treatment tool has been removed based on the operation information.

12. The endoscope system as defined in claim 1,
the discharge operation being an operation that discharges at least one of a liquid and a solid.

13. The endoscope system as defined in claim 1, further comprising:
a forceps channel into which a treatment tool for performing the tissue treatment operation is inserted; and
a detection sensor that is the operation detection sensor, and detects whether or not the treatment tool is inserted,
the operation information acquisition section acquiring sensor information from the detection sensor as the operation information about the tissue treatment operation, and
the switch control section determining whether or not to cause the focus control section to perform the focus control process based on the sensor information.

14. A method for controlling an endoscope system comprising:
acquiring operation information about at least one operation among a discharge operation, a suction operation, and a tissue treatment operation based on sensor information from an operation detection sensor; and
determining whether or not to perform a focus control process on an optical system of an endoscopic scope based on the acquired operation information.
